(19) United States
(12) Patent Application Publication
(10) Pub. No.: US 2022/0019761 A1
(43) Pub. Date: Jan. 20, 2022

(54) INDEPENDENT-OPERATION INTELLIGENT IMAGE-TRACKING DEVICE

(71) Applicant: NEURONBASIC TECHNOLOGY INC., Santa Clara, CA (US)

(72) Inventor: RAYMOND WU, SANTA CLARA, CA (US)

(21) Appl. No.: 17/002,134

(22) Filed: Aug. 25, 2020

(30) Foreign Application Priority Data
Jul. 17, 2020 (TW) 109209141

(51) Int. Cl. G06K 9/00

(52) U.S. Cl. CPC G06K 9/00201; H04W 4/80; G06K 9/0063; G06K 9/00664

(57) ABSTRACT

The present invention mainly provides an independent-operation intelligent image-tracking device without the need for a system for pairing and receiving at both ends. The structure of this invention includes a main body of the device and a single-chip unit combined in the main body. The main body of the device is connected with a dynamic mechanism, such as a motor with its transmission assembly, which can control the movement or rotation of the main body of the device. The single-chip unit is equipped with a lens-module, an image recognition module, an image analysis module, etc., which can obtain external images, calculate and analyze the image and shadow dynamics, and transmit the analysis results to the dynamic mechanism to perform corresponding dynamic displacements to achieve the purpose of automatically tracking target images. The overall image input, analysis and tracking are all done independently, without interacting with other devices or chips, or installing any other additional software, to achieve accurate and real-time tracking.

### CROSS REFERENCES TO RELATED APPLICATIONS

N/A

### FIELD OF INVENTION

This invention is about a creative design that uses a single chip unit for independent operations to achieve real-time image tracking.

### BACKGROUND

In order to obtain the image tracking function to provide applications in specific fields, such as the application of selfie stand, the known technology mainly uses pairing system to achieve the purpose of sensing, including infrared, audio, or Bluetooth with sending and receiving technology, through the connection of the two ends of the signal, to operate a further predetermined mechanical action. For example, Taiwan Invention No. 581193, which uses a Bluetooth connection unit combined with audio signals to transmit sensing data for linkage, or Taiwan Invention No. 691908 (that is, U.S. Pat. No. 10,630,878), which uses infrared transmission and reception, is limited to pairing induction tracking and can only be completed within a specific wavelength and frequency range. However, the induction of these methods often causes misoperation due to environmental interference, or poor signal reception, so the actual application is still unsatisfactory and needs to be improved.

In addition, as in the Taiwan Invention Patent No. 653581, some specific dynamic images are set first to determine whether the preset object enters a preset area in a sampling frame of the image capturing unit, so as to detect the default object is included in the dynamic image to determine the tracking result and positioning. However, this design is limited to the application of setting data, since a storage unit and a database are required, and only the function of taking pictures after positioning is provided, which is not really practical.

Other traditional Bluetooth tracking devices mainly use the built-in lens and microprocessor of the mobile phone to perform calculations. Therefore, additional mobile phone application software is required for use and excessive power consumption of the mobile phone, which is obviously not economical.

### SUMMARY

The present invention mainly provides an independent-operation intelligent image-tracking device without the need for a system for pairing and receiving at both ends. The structure of this invention includes a main body of the device and a single-chip unit combined in the main body. The main body of the device is connected with a dynamic mechanism, such as a motor with its transmission assembly, which can control the movement or rotation of the main body of the device. The single-chip unit is equipped with a lens-module, an image recognition module, an image analysis module, etc., which can obtain external images, calculate and analyze the image and shadow dynamics, and transmit the analysis results to the dynamic mechanism to perform corresponding dynamic displacements to achieve the purpose of automatically tracking target images. The overall image input, analysis and tracking are all done independently, without interacting with other devices or chips, or installing any other additional software, to achieve accurate and real-time tracking.

### BRIEF DESCRIPTION OF THE DRAWINGS

The FIGURE is a schematic diagram of the combined structure of the present invention.

### DETAILED DESCRIPTION AND PREFERRED EMBODIMENT

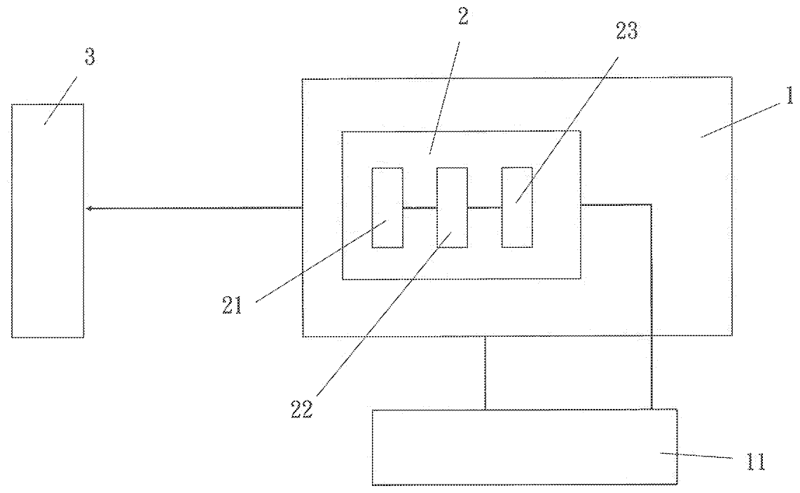

Referring to FIG. 1, this invention is related to a design of an independent-operation intelligent image-tracking device, which includes a main body 1 and a single chip unit 2 integrated in the main body 1. The main body 1 is provided with a dynamic mechanism 11, such as a motor, which is combined with transmission components such as gear sets and connecting rods for moving or rotating the main body 1. The single chip unit 2 is provided with a lens-module 21, an image recognition module 22, and an image analysis module 23, and is electrically connected to the dynamic mechanism 11. It can obtain an external image 3, calculate and analyze the image and image movements, and transmit the analysis result to the dynamic mechanism 11 to make a related dynamic displacement corresponding to the target image, and motivates the main body 1 to change its direction and/or angle, to achieve the purpose of continuously tracking images of the external objects.

The present invention can be applied to camera selfie stand for cameras or mobile phones. By the functions of continuously tracking and images-setting of the single chip unit 2, when the user is taking selfies or taking pictures, the single-chip unit 2 is tracking the image 3, and the dynamic mechanism 11 is motivated to rotate the main body 1 accordingly. Therefore, the camera or mobile phone placed on the selfie stand also moves, and can continue face the tracked the image 3 to obtain real-time and effective follow-up function.

In addition, when the main body of the device of the invention is a toy car or any tracking device, the toy car or tracking device can also be used to track the user's images and move with the actions.

In summary, the feature of this invention is to use image tracking technology to control the operation of the dynamic mechanism, and change the steering, angle, or moving position of the main body of the device. It can follow the position of the image at any time, providing applications for selfie recording, toy cars, or electric plush toys. The implementation of the overall combination does not use infrared or Bluetooth pairing systems to avoid interference from external signals. It also does not use lenses of cameras or the mobile phone, so it can reduce the focus error when capturing images. And it does not require memory and pre-stored database, so there is no need for passive comparison between memory and pre-stored database. Instead, the single-chip unit itself is used for active imaging, recognition, and analysis, and then real-time control of the linkage of the dynamic mechanism, which can provide more diverse fields in applications. Hence, the present application is significantly progressive.

What is claimed is:

1. An independent-operation intelligent image-tracking device including a main body and a single chip unit integrated in the main body, wherein the main body is provided with a dynamic mechanism, and the single chip unit is provided with a lens-module, an image recognition module, and an image analysis, and is electrically connected to the dynamic mechanism.

2. The independent-operation intelligent image-tracking device as in claim 1, wherein the main body of the device is a camera selfie stand, a toy car, or an electric plush toy.

3. The independent-operation intelligent image-tracking device as in claim 1, wherein the dynamic mechanism includes a motor combined with a gear set and a connecting rod assembly to motivate the movement or rotation of the main body of the device.
